(19) United States
(12) Patent Application Publication
(10) Pub. No.: US 2007/0224361 A1
(43) Pub. Date: Sep. 27, 2007

(54) Method and apparatus for marking a synthetic turf field

(76) Inventor: Alain Bissonnette, Quebec (CA)

Correspondence Address: FACTOR & LAKE, LTD, 1327 W. WASHINGTON BLVD., SUITE 5G/H, CHICAGO, IL, 60607, US

(21) Appl. No.: 11/369,886

(22) Filed: Mar. 7, 2006

(51) Int. Cl. B05D 1/02; B05B 17/04; B05D 5/00

(52) U.S. Cl. 427/421.1; 239/11

(57) ABSTRACT

A system and method for of spraying a liquid onto monofilament fibers of a synthetic turf system includes providing a sprayer having a nozzle and positioning the nozzle at an angle to the surface of the synthetic turf system in a range of approximately 30-60°.

### FIELD OF THE INVENTION

The present invention is directed toward a synthetic surface system; and more particularly, to coating monofilament fibers of a synthetic turf field for display purposes.

### BACKGROUND OF THE INVENTION

The utilization of synthetic turf surfaces to replace natural grass surfaces is well known. Natural grass surfaces generally require a great deal of maintenance, do not stand up well to wear, and do not grow well in partly or fully enclosed environments. In contrast, synthetic turf surfaces require less maintenance, stand up much better to wear, and can be used in closed environments. Today's synthetic turf systems are also more durable and aesthetic than those used in the past. Event surfaces utilizing present synthetic turf systems are capable of quickly and repeatedly being modified wherein the synthetic grass can be color coated to include school, team, or sponsorship logos as well as being readily reconfigurable dependent upon the dimensions of the event's playing surface, e.g., soccer, football, and track. For these reasons, synthetic turf systems are increasingly being utilized in place of natural grass surfaces in many applications; such as indoor and outdoor recreational facilities, airports, and home and industrial landscaping.

Synthetic turf surfaces typically include fibers or ribbons of various materials representing blades of natural grass that extend vertically from a backing member or mat. The backing member is generally placed above a prepared surface, such as compacted soil, rocks, stones, etc., and combinations thereof. A layer of particulate material—frequently referred to as infill—may be placed over the backing member and interspersed among the fibers, wherein the fibers extend through and above the infill. The infill provides, amongst other things, a supportive base for the synthetic fibers. The infill layer may include several courses of particulate material comprising hard and resilient particles, e.g., sand, rubber, and combinations thereof; and is also capable of providing an increased resiliency to the synthetic turf system.

The synthetic grass blades commonly implemented in infill-type synthetic turf systems are relatively long (as compared to non-infilled systems); for example, between 1½-2½ inches long—so as to provide optimum surface “feel” and appearance.

Conventionally, the combination of fiber-positioning and infill retention was accomplished, in part, through the use of relatively flexible slit-film-type polymeric blades. Such blades were typically woven or tufted into the backing layers of the synthetic grass system, and then fibrillated into a web-like structure to maximize infill support and retention of the infill by the blades. The free ends of these fibers tend to bend over the top of the infill to create an infill trapping effect. Coloring of the slit-film-type polymeric blades is accomplished by vertically placing the nozzles of the spraying device directly overhead.

Another synthetic blade now used in synthetic turf systems is the monofilament fiber. Monofilament blades for synthetic grass are manufactured by extruding a resultant single polymer (or similar) blade from a device, such as a spinneret, into a long polymer strand, finishing that strand and then cutting single monofilament pieces from the strand. Typically, multiple monofilament elements are bound together at their base to create a single bundle of blades, which are then operatively attached, e.g., tufted; to the backing layer of the synthetic grass system.

Monofilament fibers are relatively more rigid and stiff than non-monofilament fibers. While the stiffer monofilament fiber does offer many benefits—such as a ball rolling closer to the way it would roll or bounce on a natural turf surface—there unfortunately are some undesired side-effects. Specifically, unlike the free ends of the less rigid non-monofilament fibers, which may fold over in a relaxed orientation, such an effect is not as prevalent when stiffer monofilament fibers are used. Therefore, overhead coloring techniques commonly used for coating non-monofilament fibers of a synthetic turf system are inadequate for coating monofilament fibers because the more upright nature of the monofilament fiber does not lend itself to being coated from directly above. As such, utilizing the same coating technique commonly used to color non-monofilament fibers for a monofilament application will increase costs because much of the coloring liquid fails to adhere to the monofilament fibers, which may result in increased costs due to waste and time required to more fully coat the monofilament fibers.

It is therefore an object of the present invention to overcome these and other issues associated with conventional mechanisms for coating synthetic turf systems. These and other objects will become apparent to one of ordinary skill in the art in light of the specification, claims, and drawings appended hereto.

The present invention is intended to address these as well as other issues.

### SUMMARY OF THE INVENTION

The present invention is directed to a system and method of spraying a colored liquid onto monofilament fibers of a synthetic turf system. A nozzle of a sprayer is positioned at an angle to the surface of the synthetic turf system in a range of approximately 30-60°. The liquid is sprayed onto the monofilament fibers in a first direction, and preferably repeated in a second direction.

Another aspect of the present invention includes a sprayer for coating a colored liquid onto monofilament fibers of a synthetic turf system. The sprayer comprises a vehicle and a container. The container is operatively attached to the sprayer and capable of housing the liquid to be sprayed onto the monofilament fibers. At least one nozzle is operatively connected to the container and is capable of being positioned above the surface of the synthetic turf system at a height having a range of approximately 4-18 inches. The at least one nozzle is positioned at an angle to the surface of the synthetic turf system in a range of approximately 30-60°, wherein the at least one nozzle dispenses the liquid onto the monofilament fibers at a pressure having an approximate range of 1000-1700 psi.

It is to be understood that the sprayer of the present invention can be a hand-held device wherein manual application of the liquid to the synthetic turf system is accomplished by the use of a wand. The sprayer can also be operatively connected to a vehicle that may include a mover, e.g., motor, engine, to move the vehicle such that the nozzle disperses the liquid at a selected rate onto the monofilament fibers during a single pass over the synthetic turf system.

### BRIEF DESCRIPTION OF THE DRAWINGS

The present invention will now be described with reference to the drawings wherein:

FIG. 1 is a drawing depicting one embodiment of the present invention;

FIG. 2 is a drawing depicting another embodiment of the present invention; and,

FIG. 3 is a drawing depicting a front view of another embodiment of the present invention.

### DETAILED DESCRIPTION OF THE PRESENT INVENTION

While this invention is capable of embodiment in many different forms, there is shown in the drawings and will herein be described in detail one or more embodiments with the understanding that the present disclosure is to be considered as an exemplification of the principles of the present invention and is not intended to be limited to the embodiments illustrated.

It is to be understood that like or analogous elements and/or components referred to herein may be identified throughout the drawings with like reference characters.

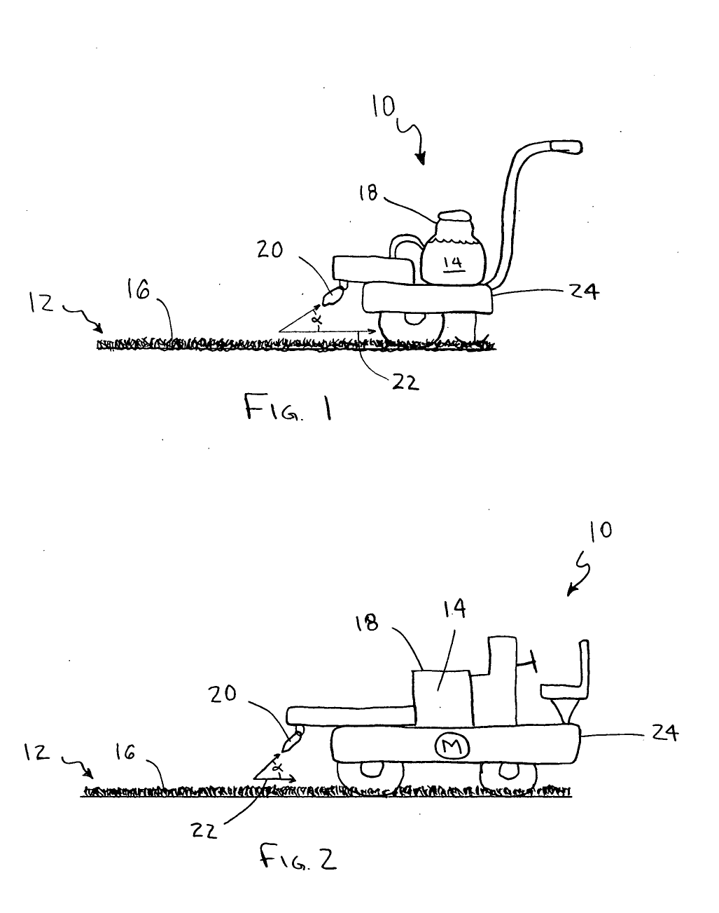

One embodiment of the present invention is partially shown in FIG. 1 as a device 10, i.e., a sprayer, for dispersing a liquid 14 or coloring agent to coat monofilament fibers 16 of a synthetic turf system 12. The sprayer 10 comprises a container 18 capable of housing the coating liquid 14, e.g., paint, stain; to be sprayed onto the monofilament fibers 16. At least one nozzle 20 is operatively connected to the container 18 and positioned above the surface of the synthetic turf system 12 at a height having a range of approximately 4-18 inches. The at least one nozzle 20 is further positioned at an angle α to the surface of the synthetic turf system 12 in a range of approximately 30-60°, wherein the at least one nozzle disperses the liquid 14 onto the monofilament fibers 16 at a pressure having an approximate range of 1000-1700 psi. Preferably, the at least one nozzle 20 is positioned at an angle α—approximately 30-45°—with respect to the horizontal plane 22 of the surface of the synthetic turf system.

As opposed to the overhead positioning of the spray nozzle(s) 20 during color coating of a synthetic turf system having non-monofilament fibers 16, the angled positioning of the spray nozzle(s) for coating monofilament fibers is beneficial because the profile of the stiffer monofilament fibers is aligned for receiving the sprayed liquid 14.

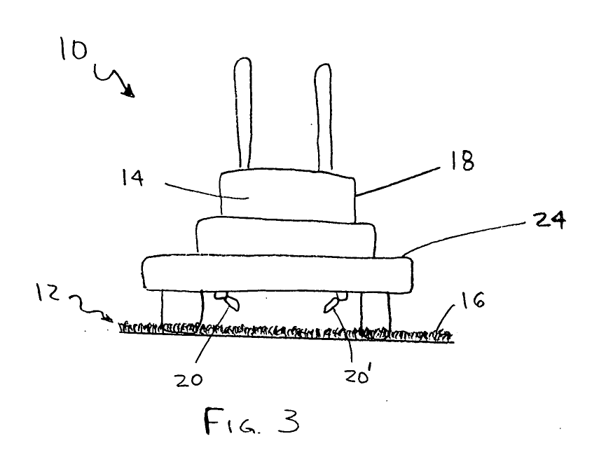

In addition, the liquid 14 can be applied to the monofilament fibers 16 via personnel using a spray wand. The present invention further envisions the use of a vehicle 24 to disperse the liquid. The vehicle 24 can be manually or self propelled, e.g., engine, or motor. Referring to FIG. 2, the container 18, sprayer 10, and at least one nozzle 20, are operatively connected to the vehicle 24. The at least one nozzle 20 is positioned approximately a distance of 4-18 inches above the surface of the synthetic turf system and at an angle, α—approximately 30-60° to the surface of the synthetic turf system 12. Both the height and angle of the at least one nozzle 20 is adjustable. Depending upon the physical dimensions—length and width—of coating to be applied to the monofilament fibers 16, e.g., territory lines, end zones, and logos; the at least one nozzle 20 utilizes approximately 1000-1700 psi to disperse the liquid 14. Preferably, the at least one nozzle 20 is angled at approximately 30-45° with respect to the horizontal plane 22 of the surface of the synthetic turf system.

In one application, the liquid 14 applied to the synthetic turf system via a wand or the use of the vehicle 24 is preferably dispersed at a volume rate of approximately 200 square feet per gallon. It is to be understood that the liquid 14 can be dispersed at other rates in operative cooperation with the movement of the nozzle 20 over the synthetic surface 12. As such, the pressure, volume rate, and height, angle and travel velocity of the at least one nozzle 20 can be operatively configured to ensure proper application of the liquid 14. The spray nozzle(s) 20 may be passed over the surface of the synthetic turf system in two opposing directions to ensure proper coating of the monofilament fibers 16.

In another embodiment of the present invention shown in FIG. 3, the sprayer 10 is configured for dispersing the liquid 14 in both a first and a second direction during one “pass” of the sprayer over the synthetic turf system 12. At least a first nozzle 20—positioned to face toward a first direction and angled in accordance with the present invention—is configured opposite a second, appropriately angled nozzle 20′, which is positioned to face toward a second direction and opposing that of the first nozzle. The nozzles 20, 20′ are spaced apart, e.g., between 4-8 inches, and are preferably configured substantially perpendicular to the linear axis of movement of the sprayer 10. In this configuration, both nozzles 20, 20′ may be used simultaneously to disperse the liquid 14 onto the monofilament fibers 16 of a synthetic turf system 12. Although both nozzles 20, 20′ are angled in accordance with the present invention, it is to be understood that only one of the nozzles may need to be angled accordingly. Furthermore, the liquid 14 does not need to be simultaneously dispersed from both nozzles 20, 20′. That is, a plurality of nozzles may be aligned with the first nozzle 20 toward the first direction, and a plurality of other nozzles may be aligned with the nozzle 20′ toward the second direction, wherein the opposing nozzles are linearly staggered with respect to each other such that a specific area of the monofilament fibers 16 may be coated by one nozzle 20 first, and then coated by the other nozzle 20′ afterward. The present invention further contemplates that the nozzles of the opposing rows do not need to be staggeredly configured, but may be similarly functionally controlled via a programmable logic computer or microcomputer to accomplish alternately dispersing the liquid 14 on the monofilament fibers 16.

The sprayer 10 of the present invention can also be utilized for applying a removing agent to the monofilament fibers 16 of the synthetic turf system 10. Most removing agents commonly known to one of ordinary skill in the art may be utilized and are typically applied at a rate of 500 square feet per gallon.

Other application parameters known to those of ordinary skill in the art and not discussed in specific detail herein can be utilized with the various aspects of the present invention shown above. For example, an airless sprayer such as Graco's Line Laser™ 3000, 390, or 490 (portable) can be used for dispersing the liquid 14 to the monofilament fibers 16 of the synthetic turf system 12. Prior to coating the monofilament fibers 16, the application of a primer coat is frequently recommended. Depending on the area to be coated, the spray nozzles 20 may include tip model nos. 415/417—for use in painting logos—and 315/317—for painting 4 inch line widths. The coating of large areas—football end zones—typically requires 1500-1700 psi of pressure with the nozzle positioned approximately 18 inches above the surface, while smaller areas—4 inch wide lines—generally require 1000-1200 psi of pressure and a nozzle height of 4-8 inches above the surface. The colored liquid can be applied to the monofilament fibers 16 when the ambient temperature preferably does not fall below 50° F. during coating and within 24 hours of its application. It is also preferable to allow the coated liquid time to cure, e.g., 6-8 hours at 70° F. and 50% humidity, before event use or applying another coating of the liquid 14.

While specific embodiments have been illustrated and described, numerous modifications may come to mind without significantly departing from the spirit of the invention, and the scope of protection is only limited by the scope of the accompanying Claims.

What is claimed is:

1. A method of spraying a liquid onto monofilament fibers of a synthetic turf system, the method comprising the steps of:
providing a sprayer including a nozzle;
positioning the nozzle at an angle to the surface of the synthetic turf system in a range of approximately 30-60°; and,
spraying a liquid in a first direction onto the monofilament fibers.

2. The method of claim 1, further comprising positioning the nozzle at a height above the surface of the synthetic turf system at a range of approximately 4-18 inches.

3. The method of claim 1, further comprising spraying the liquid in a second direction onto the monofilament fibers.

4. The method of claim 1, further comprising spraying the liquid onto the monofilament fibers at a pressure having an approximate range of 1000-1700 psi.

5. The method of claim 1, further comprising spraying the liquid on the monofilament fibers at a rate of approximately 200 square feet per gallon of liquid.

6. The method of claim 1, further comprising spraying the liquid on the monofilament fibers when the ambient temperature is approximately equal to or greater than 50° F.

7. A sprayer for coating a liquid onto monofilament fibers of a synthetic turf system, the sprayer comprising:
a vehicle;
a container operatively attached to the vehicle, the container capable of housing the liquid to be sprayed onto the monofilament fibers; and,
at least one nozzle operatively connected to the container, the at least one nozzle capable of being positioned above the surface of the synthetic turf system at a height having a range of approximately 4-18 inches, the at least one nozzle being positioned at an angle to the surface of the synthetic turf system in a range of approximately 30-60°, wherein the at least one nozzle being capable of dispensing the liquid onto the monofilament fibers at a pressure having an approximate range of 1000-1700 psi.

8. The sprayer of claim 7, wherein the angle is approximately 45°.

9. The sprayer of claim 7 further comprising a mover being operatively connected to the vehicle, wherein the mover being capable of moving the vehicle such that the at least one nozzle disperses the liquid onto monofilament fibers of the synthetic turf system at a selected rate.

10. The sprayer of claim 9 wherein the selected rate is approximately 200 square feet per gallon of liquid.

11. The sprayer of claim 7, wherein the mover is a motor or engine.

12. A sprayer for coating a liquid onto monofilament fibers of a synthetic turf system, the sprayer comprising:
a vehicle including an axis of movement during operation;
a container operatively attached to the vehicle, the container capable of housing the liquid to be sprayed onto the monofilament fibers;
a first nozzle operatively connected to the container, the first nozzle being positioned in a first direction substantially perpendicular to the axis of movement and further being positioned above the surface of the synthetic turf system at a height having a range of approximately 4-18 inches, and further being positioned at an angle to the surface of the synthetic turf system in a range of approximately 30-60°, wherein the first nozzle is capable of dispensing the liquid onto the monofilament fibers at a pressure having an approximate range of 1000-1700 psi;
a second nozzle operatively connected to the container, the second nozzle being positioned in a second direction substantially perpendicular to the axis of movement and further being positioned above the surface of the synthetic turf system at a height having a range of approximately 4-18 inches, the second nozzle being positioned at an angle to the surface of the synthetic turf system in a range of approximately 30-60°, wherein the second nozzle is capable of dispensing the liquid onto the monofilament fibers at a pressure having an approximate range of 1000-1700 psi.
